(19) United States
(12) Patent Application Publication
(10) Pub. No.: US 2025/0354570 A1
(43) Pub. Date: Nov. 20, 2025

(54) Hydraulic System

(71) Applicant: HYDAC Mobilhydraulik GmbH, Sulzbach / Saar (DE)

(72) Inventors: Timo Kiefer, Saarlouis (DE); Benjamin Kihm, Ensch (DE)

(73) Assignee: HYDAC Mobilhydraulik GmbH, Sulzbach / Saar (DE)

(21) Appl. No.: 18/866,854

(22) PCT Filed: Jun. 6, 2023
(86) PCT No.: PCT/EP2023/065069

§ 371 Date: Nov. 18, 2024

(30) Foreign Application Priority Data
Jun. 9, 2022 (DE) 10 2022 002 037.8

(51) Int. Cl. F15B 11/028; F15B 13/04; F15B 13/044

(52) U.S. Cl. CPC F15B 11/028; F15B 13/0401; F15B 13/044; F15B 2211/526

(57) ABSTRACT

The disclosure relates to a hydraulic system having a hydraulically actuable working cylinder which has a cylinder housing with a piston-rod unit that is guided in longitudinal movement therein, is actuable in opposite directions and subdivides the cylinder housing into a piston chamber and a rod chamber, and having two proportional pressure control valves, of which one is assigned to the piston chamber and the other is assigned to the rod chamber, wherein a connecting line is connected in a fluid-conducting connection between the rod chamber and the proportional pressure control valve assigned to the rod chamber, said connecting line being guided to an input side of the proportional pressure control valve for the piston chamber such that, when the piston-rod unit is extended, the fluid displaced from the rod chamber passes into the piston chamber of the cylinder housing.

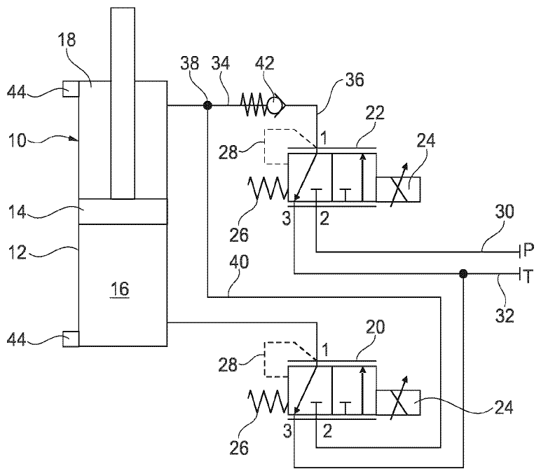

### CROSS-REFERENCE TO RELATED APPLICATION

This application claims priority to German Patent Application No. DE 10 2022 002 037.8, filed on Jun. 9, 2022 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a hydraulic system having a hydraulically actuatable working cylinder which has a cylinder housing with a piston rod unit which is guided in longitudinal movement therein, is actuatable in opposite directions and subdivides the cylinder housing into a piston chamber and a rod chamber, and having two proportional pressure control valves, of which one is assigned to the piston chamber and the other is assigned to the rod chamber.

EP 1 642 035 B1 discloses a generic hydraulic system having a hydraulically actuatable drive part with two opposite drive directions, at least one pressure regulator, in particular in the form of a valve, being provided for at least one drive direction, and comprising a restrictor between the pressure regulator and the drive part, sensor technology being provided to detect the load state of the drive part, in particular in the form of a pressure transducer, which is connected in the associated fluid-conducting line between the restrictor and drive part for each drive direction of the drive part, the pressure transducer detecting the load situation at the drive part at any moment in time, the pressure regulator, in its basic position, connecting the secondary side of the system to a tank port, and the secondary pressure being regulated to the pressure of the proportional pilot control minus the spring force applied to the valve piston of the pressure regulator when the pressure regulator is actuated.

This creates an open and closed loop control concept, with which the pressure, displacement, speed and position of movable components of the respective selected drive part can be detected based on a basic system, which may be known in the art (DE 44 07 370 A1), for hydraulically actuatable drive parts such as hydraulic working cylinders or hydraulic drive motors. Very dynamic and precise control operations can be performed, depending on the specific hydraulic application, via the respective pressure regulator, in particular in valve form. The directional control valve technology which is otherwise usually used to control the movement of a drive part is no longer required with this system using pressure regulators and corresponding restrictors, with the result that power loss and fault susceptibility are reduced while simultaneously increasing the response time of the hydraulic system.

Despite these benefits, the solution requires increased energy input as hydraulic medium, such as oil, must be drained from the rod side or the piston side to the tank in order to increase or reduce the force on the piston rod unit of the working cylinder alternately and in so doing the pressure control valves are accordingly energised to be constantly ready to control.

### SUMMARY

A need exists for an improved hydraulic system and a corresponding method. The need is addressed by the subject matter of the independent claim(s). Embodiments of the invention are described in the dependent claims, the following description, and the drawing(s).

### BRIEF DESCRIPTION OF THE DRAWINGS

The FIGURE shows an underlying design of a hydraulic system in the form of a hydraulic circuit diagram.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a connecting line is connected in a fluid-conducting connection between the rod chamber and the proportional pressure control valve assigned to the rod chamber, said connecting line being guided to an inlet side of the proportional pressure control valve for the piston chamber such that, when the piston rod unit is extended, the fluid displaced from the rod chamber passes into the piston chamber of the cylinder housing. This permits a kind of regenerative operation in which, when the working cylinder is extended, the hydraulic medium to be discharged on the rod or annulus side is not guided to the tank, but rather, as part of an injection operation, is used directly for a corresponding stroke motion for the piston side.

Due to the pressure transmission in a conventional differential cylinder used as a working cylinder, the hydraulic pressure on the rod or annulus side of the working cylinder is always higher than on the piston side, such that the piston side can be supplied with fluid in an energy-saving manner from this higher pressure level. In this manner, it is possible to regulate force quite easily with the hydraulic system, for example, the force can be kept constant at the piston rod unit of the differential cylinder despite disruptive influences occurring. Furthermore, according to the specification, an actuating force can be set, and the position of the piston rod unit can also be adjusted if necessary. This therefore has no parallel in the prior art.

In some embodiments, it is provided that a, for example spring-loaded, non-return valve is arranged in the fluid-conducting connection between the rod chamber and the proportional pressure control valve assigned to the rod chamber in front of a branch point into the connecting line, said non-return valve opening in the direction of the rod chamber towards the branch point. The aforementioned non-return valve could also be omitted, but by using the aforementioned non-return valve, this always guarantees that the volume flow to be discharged from the rod or annulus side also automatically flows towards the piston side and does not inadvertently flow back into the tank via the return line.

Further embodiments of the system are described in the dependent claims.

The teachings herein also include a method for operating such a hydraulic system, wherein, by means of a computer control system and sensors connected thereto, such as pressure and/or displacement sensors, both the piston side and the rod side of the working cylinder can be monitored to establish whether the actuating force to be set has also been reached, this force being designed to be limited insofar as the associated maximum pressure set on the piston side corresponds to the maximum pressure on the rod side, which in turn corresponds to the supply pressure of the pressure supply source. This thus results beneficially in a similar behaviour to that observed in a hydraulic plunger circuit, i.e., only the annular surface is subjected to pressure to insert the working cylinder, but both sides of the piston are subjected to pressure to extend the cylinder. Assuming that the piston surface is twice the size of the piston surface on the rod side, this then causes a predefinable force to act on the piston surface, which is counteracted by half as much force on the rod or annular surface side. In this manner, the piston thus moves apart with only ‘half the force’ in an energy-saving manner.

The solution is described in more detail below with the aid of another embodiment. Specific references to components, process steps, and other elements are not intended to be limiting.

The FIG. shows a hydraulic system having a hydraulically actuatable working cylinder 10, which is designed as a so-called differential cylinder. The working cylinder 10 comprises, in the usual manner, a cylinder housing 12 with a piston rod unit 14, which is guided in longitudinal movement therein, is actuatable in opposite directions and subdivides the cylinder housing 12 into a piston chamber 16, and a rod chamber 18, which is also referred to in technical jargon as an annulus. The circuit shown in the FIGURE also comprises two proportional pressure control valves 20, 22, of which one proportional pressure control valve 20 is assigned to the piston chamber 16 and the other pressure control valve 22 is assigned to the rod chamber 18.

Corresponding proportional valves 20, 22 are customary and in each case form a continuous-action valve that not only permits discrete valve switching positions with the aid of a proportional solenoid 24 but also allows a constant transition of the valve opening. In hydraulics, such proportional valves 20, 22 are in particular frequently used where variable volume flows need to be controlled. Accordingly, the valves 20, 22 can assume any intermediate positions between one valve position and the other. In the valve position according to the FIGURE, the two valves 20, 22 are shown in their non-actuated basic position, which is assumed when the proportional solenoid 24 is de-energised by the action of a valve spring 26 and under the effect of a fluid pressure, which acts on the slider of the respective valve 20, 22 via a control line 28 aligned to the force of the valve spring 26, the respective control line 28 recording the pressure at the outlet 1 of the respective valve 20, 22. In addition to an outlet 1, each of the two valves 20, 22 comprises two inlets 2, 3, the inlet 2 of the proportional pressure control valve 22 being connected to a pressure supply port P, to which the fluid pressure of a pressure supply source is applied, for example achieved by means of a conventional hydraulic pump (not shown). The further inlet 3 of the valve 22 is also connected to a return line 32, like the inlet 3 of the valve 20, said return line leading to a tank T as is usual for such systems.

A connecting line 40 is connected to a branch point 38 in a fluid-conducting connection 34 between the rod chamber 18 and the proportional pressure control valve 22 assigned to the rod chamber 18, said connecting line leading to the other inlet side 2 of the proportional pressure control valve 22 for the piston chamber 16 such that, when the piston rod unit 14 is extended, as shown towards the top on the FIGURE, the fluid displaced from the rod chamber 18 when the proportional pressure control valve 20 is controlled by actuating the corresponding proportional solenoid 24 passes into the piston chamber 16 of the cylinder housing 12.

As shown in the FIG., both valves 20, 22 are shown in their basic position, in which the respective outlet 1 is in fluidic connection with the corresponding inlet 3, which leads via the return line 32 to the tank T for both valves 20, 22. In order to prevent fluid inadvertently flowing back from the branch point 38 in the direction of the outlet 1 of the proportional pressure control valve 22, a spring-loaded non-return valve 42 is connected in the corresponding connecting line 36, said non-return valve opening in a spring-loaded manner in the direction towards the branch point 38.

In order to extend the piston rod unit 14 from the cylinder housing 12, the proportional pressure control valve 22 corresponding to the rod chamber 18 moves into an actuated position, in which fluid for example originating from a hydraulic pump at a predefined pressure passes into the piston chamber 16 when the non-return valve 42 is opened accordingly via the branch point 38 and the connecting line 40 and via the proportional control valve 20 assigned to the piston chamber 16, which is in a similarly actuated position, such that, due to the surface ratio between the rod or annulus side to the piston side, the extension movement of the unit 14 is supported.

In the opposite direction, in order to insert the piston rod unit 14 into the cylinder housing 12 of the working cylinder 10, the proportional pressure control valve 22 belonging to the rod chamber 18 passes into an actuated position in which fluid at a predefinable pressure, once again originating for example from the hydraulic pump P, passes into the rod chamber 18, while simultaneously displacing fluid from the piston chamber 16 via the non-actuated proportional pressure control valve 20 associated therewith in the direction of the return line 32 to the storage tank T. As the proportional pressure control valve 20 for the piston chamber 16 then assumes its basic position shown in the FIG., the pump pressure prevailing in the connecting line 40 from the pressure supply source P is connected to the accordingly inlet 2 of the valve 20 such that fluid volume blocking displacement from the piston chamber 16 in the direction of the storage tank T from the connection point 1 to 3 of the valve 20 is not prevented. As is also shown in the FIG., the same inlet 3 of both proportional pressure control valves 20, 22 is connected to the return line 32 and the respective inlet 3 is connected at least in a fluid direction to the piston chamber 16 when the respective proportional pressure control valve 20, 22 is in the non-actuated original position. As the return valve 42 is not compulsory in the design of the hydraulic system shown in the FIGURE, if this is omitted, the rod chamber 18 would thus also be connected via the inlet 3 and the return line 32 to the tank T when the valve 22 is in the illustrated basic position.

In a higher-level logic incorporating a computer control system, it is possible to check whether the force to be set on the piston rod unit 14 can also be reached. This is limited by the design insofar as the maximum pressure to be set on the piston side, i.e. the piston chamber 16, corresponds to the maximum annular pressure i.e. the pressure in the rod chamber 18, which in turn corresponds to the pump pressure of the pump supply source P. This results in behaviour that is comparable to that of a hydraulic plunger circuit, where

Fₘₐₓ=p_{Ko}A_{Ko}−p_{Ri}A_{Ri}=p_{P}(A_{Ko}−A_{Ri}), where
p_{max,Ko}=p_{max,Ri} and p_{max,Ri}=p_{P}, in which
p_{Ri} is the pressure on the annulus or rod side,
A_{Ri} is the area of the piston on the annulus or rod side,
p_{Ko} is the pressure on the piston side, and
A_{Ko} is the area of the piston on the piston side.

Conventional pressure sensors 44 are used to monitor the pressure situation both in the piston chamber 16 and in the rod chamber 18. Additionally or alternatively to the two pressure sensors 44 shown, a distance measurement system, which is not shown or described in any further detail, could also be used to monitor the position of the piston rod unit 14, providing information about the pressure situation in the chambers 16, 18.

The corresponding operating method allows force for the working cylinder 10 to be regulated, wherein an actuating force for the piston rod unit 14 can be set according to the specification or the force can, if necessary, be kept constant if disruptive influences arise on the unit 14. Furthermore, it is possible to carry out position adjustment with the corresponding hydraulic system for the working cylinder 10.

It is possible, with the solution according to the teachings herein, to use the oil draining on the annulus side of the differential cylinder 10 for the piston side. Due to the selected pressure transmission in the design of the differential cylinder, the pressure on the annulus side is always higher than on the piston side, with the result that the piston side can be supplied in an energy-efficient manner from this higher pressure level.

The proportional pressure control valves 20, 22 used in this case should not be regarded as conventional directional control valves; instead, these (20, 22) allow a specific volumetric quantity through the valve dependent on the pressure difference at the valve and thus regulate the pressure in the system. Accordingly, the pressure in the respective chamber 16, 18 of the hydraulic cylinder 10 can be adjusted in proportion to the control signal of the corresponding valve 20, 22, which is not possible with the other kind of directional control valves.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A hydraulic system having a hydraulically actuatable working cylinder which has a cylinder housing with a piston rod unit which is guided in longitudinal movement therein, is actuatable in opposite directions and subdivides the cylinder housing into a piston chamber and a rod chamber, and having two proportional pressure control valves, of which one is assigned to the piston chamber and the other is assigned to the rod chamber, wherein a connecting line is connected in a fluid-conducting connection between the rod chamber and the proportional pressure control valve assigned to the rod chamber, said connecting line being guided to an inlet side of the proportional pressure control valve for the piston chamber such that, when the piston rod unit is extended, the fluid displaced from the rod chamber passes into the piston chamber of the cylinder housing.

12. The hydraulic system of claim 11, wherein the proportional pressure control valves can be actuated electromagnetically and connect a return line with an inlet in their non-actuated original position.

13. The hydraulic system of claim 11, wherein, in order to extend the piston rod unit from the cylinder housing, the proportional pressure control valve belonging to the rod chamber passes into an actuated position in which fluid at a predefinable pressure passes via the connecting line and via the proportional pressure control valve assigned to the piston chamber, which is in a similarly actuated position, into the piston chamber.

14. The hydraulic system of claim 11, wherein, in order to insert the piston rod unit into the cylinder housing of the working cylinder, the proportional pressure control valve belonging to the rod chamber passes into an actuated position in which fluid at a predefinable pressure passes into the rod chamber, while simultaneously displacing fluid from the piston chamber via the non-actuated proportional pressure control valve associated therewith in the direction of the return line to the storage tank.

15. The hydraulic system of claim 11, wherein the respective proportional pressure control valve is configured to be identical to the other proportional pressure control valve.

16. The hydraulic system of claim 11, wherein the same inlet of both proportional pressure control valves is connected to the return line, said inlet being connected at least in a fluid direction to the piston chamber when the respective proportional pressure control valve is in the non-actuated original position.

17. The hydraulic system of claim 11, wherein the outlet of the proportional pressure control valve belonging to the rod chamber is connected for at least some of the time to the further inlet of the proportional pressure control valve belonging to the piston chamber via the connecting line.

18. The hydraulic system of claim 11, wherein the further inlet of the proportional pressure control valve belonging to the rod chamber is connected to a pressure supply line.

19. The hydraulic system of claim 11, wherein a spring-loaded non-return valve is arranged in the fluid-conducting connection between the rod chamber and the proportional pressure control valve assigned to the rod chamber in front of a branch point into a further connecting line, said non-return valve opening in the direction of the rod chamber towards the branch point.

20. A method for operating a hydraulic system, wherein, using a computer control system and sensors connected thereto, such as pressure sensors, both a piston side and a rod side of the working cylinder can be monitored to establish whether an actuating force to be set has also been reached, this force being designed to be limited insofar as an associated maximum pressure to be set on the piston side corresponds to a maximum pressure on the rod side, which in turn corresponds to the supply pressure of the pressure supply source.

21. The method of claim 20, wherein the hydraulic system comprises a hydraulically actuatable working cylinder which has a cylinder housing with a piston rod unit which is guided in longitudinal movement therein, is actuatable in opposite directions and subdivides the cylinder housing into a piston chamber and a rod chamber, and having two proportional pressure control valves, of which one is assigned to the piston chamber and the other is assigned to the rod chamber, wherein a connecting line is connected in a fluid-conducting connection between the rod chamber and the proportional pressure control valve assigned to the rod chamber, said connecting line being guided to an inlet side of the proportional pressure control valve for the piston chamber such that, when the piston rod unit is extended, the fluid displaced from the rod chamber passes into the piston chamber of the cylinder housing.

22. The method of claim 20, wherein the proportional pressure control valves can be actuated electromagnetically and connect a return line with an inlet in their non-actuated original position.

23. The method of claim 20, wherein, in order to extend the piston rod unit from the cylinder housing, the proportional pressure control valve belonging to the rod chamber passes into an actuated position in which fluid at a predefinable pressure passes via the connecting line and via the proportional pressure control valve assigned to the piston chamber, which is in a similarly actuated position, into the piston chamber.

24. The method of claim 20, wherein, in order to insert the piston rod unit into the cylinder housing of the working cylinder, the proportional pressure control valve belonging to the rod chamber passes into an actuated position in which fluid at a predefinable pressure passes into the rod chamber, while simultaneously displacing fluid from the piston chamber via the non-actuated proportional pressure control valve associated therewith in the direction of the return line to the storage tank.

25. The method of claim 20, wherein the respective proportional pressure control valve is configured to be identical to the other proportional pressure control valve.

26. The method of claim 20, wherein the same inlet of both proportional pressure control valves is connected to the return line, said inlet being connected at least in a fluid direction to the piston chamber when the respective proportional pressure control valve is in the non-actuated original position.

27. The method of claim 20, wherein the outlet of the proportional pressure control valve belonging to the rod chamber is connected for at least some of the time to the further inlet of the proportional pressure control valve belonging to the piston chamber via the connecting line.

28. The method of claim 20, wherein the further inlet of the proportional pressure control valve belonging to the rod chamber is connected to a pressure supply line.

29. The hydraulic system of claim 12, wherein the return line leads to a storage tank.

30. The hydraulic system of claim 13, wherein the fluid originates from a hydraulic pump.
